(19) United States
(12) Patent Application Publication
(10) Pub. No.: US 2009/0216732 A1
(43) Pub. Date: Aug. 27, 2009

(54) Method and apparatus for navigation system for searching objects based on multiple ranges of desired parameters

(76) Inventor: Kyte Feng, Torrance, CA (US)

Correspondence Address: MURAMATSU & ASSOCIATES, Suite 310, 114 Pacifica, Irvine, CA, 92618, US

(21) Appl. No.: 12/072,659

(22) Filed: Feb. 27, 2008

(51) Int. Cl. G06F 17/30

(52) U.S. Cl. 707/4; 707/E17.001

(57) ABSTRACT

A method and apparatus for a navigation system enables to search and display candidate objects by arranging them in a plurality of ranges of desired parameters. The method includes the steps of searching and retrieving candidate entries in a type of object specified by a user from a corresponding database, displaying a plurality of range keys on the screen of navigation system where a type of range assigned to the range keys is predetermined based on the type of object specified by the user, selecting a range by executing one of the range keys on the screen, and displaying a list of the candidate entries within the selected range on the screen.

### FIELD OF THE INVENTION

This invention relates generally to a method and apparatus to search and display information on desired objects, and more particularly, to a method and apparatus to search address book entries, points of interest or other objects by arranging such objects in a plurality of ranges of desired parameters, such as distances from a specified location, prices, numbers of prior visit, administrative regions, time lengths to reach, etc.

### BACKGROUND OF THE INVENTION

A navigation system performs travel guidance for enabling a user to easily and quickly reach the selected destination. A typical example is a vehicle navigation system where a vehicle is equipped with a navigation function to guide a driver to a destination through a calculated route. Such a navigation system detects the position of the user's vehicle, and reads out map data pertaining to an area at the current vehicle position from a data storage medium, for example, a CD-ROM (compact disc read-only memory), a DVD (digital versatile disc), or a hard disc, or from a remote data server.

FIGS. 1A-1H show a typical example of overall procedure and screen display involved in the navigation system. FIG. 1A shows an example of locator map screen of the navigation system when the destination is not specified where it displays a street on which the vehicle position VP and a name of the street. A process for specifying a destination typically starts through a main menu screen of FIG. 1B which displays menu items including a menu of “Destination” for selecting the destination.

By pressing the “Destination” in FIG. 1B, the navigation system displays a screen of FIG. 1C for specifying an input method for selecting the destination. By selecting, for example, a “Point of Interest” method in FIG. 1C, the navigation system displays selection methods of point of interest (POI) either by “Place Name” or “Place Type” in FIG. 1D. If the “Place Type” is selected, the navigation system lists categories of POIs as shown in FIG. 1E through which the user selects a desired category of POIs from the lists.

FIG. 1F shows a screen when the user has selected a “Fast Foods” category in the example of FIG. 1E. Then, the screen lists names of the fast food restaurants typically sorted by distance from the current position of the user. If the user selects a particular fast food restaurant from the list, the navigation system calculates a route to the destination as shown in FIG. 1G.

After determining the route, the navigation system starts the route guidance operation. As shown in FIG. 1H, the navigation system shows the intersection for instructing the next turn and a direction of the turn. Typically, such an instruction to turn will be made by a highlighted arrow or large characters on the screen as well as by a voice announcement when the vehicle approaches to within a predetermined distance to the intersection.

As in the foregoing, the user is able to find a point of interest (POI), an entry from a POI database or an address book, or other object through the navigation system. In finding a POI, the user may select a desired POI by specifying a category and sub-category of POI such as “Fast Foods” in the above example. The user may search a desired destination by searching entries in the address book by alphabetical order such as shown in FIG. 2.

In the example of FIG. 2, a title 23 indicates that the search method which is, in this case, an “Address Book” method and that the entries in the address book are listed below. As is well known in the art, the “Address Book” is an accumulated record of past destinations created in the navigation system automatically or manually. The list shows entries 21A-21E in the address book which are typically arranged in the alphabetical order.

The user may scroll the list of FIG. 2 by pressing the scroll (up/down) keys 70A-70B and 71A-71B to see more entries in the list. Although the screen of FIG. 2 is useful to see the list of entries and select a desired entry, it can be cumbersome to find a desired entry especially when a number of entries is large such as several tens or more. Thus, there is need of a new search and display method so that the user is able to search and find a desired entry in an easy and intuitive manner through the navigation system's screen.

### SUMMARY OF THE INVENTION

It is, therefore, an object of the present invention to provide a method and apparatus for a navigation system to search and display object entries that are divided into a plurality of ranges of various parameters.

It is another object of the present invention to provide a method and apparatus for a navigation system to search and display object entries by classifying the entries into a plurality of ranges, thereby enabling the user to find a desired entry quickly and intuitively through the navigation screen.

It is a further object of the present invention to provide a method and apparatus for a navigation system to search and display object entries flexibly and quickly by classifying the entries into a plurality of ranges of various types such as distances from a current position, time length to be reached, prices of products or services, numbers of prior visit, administrative areas such as city names, start times, etc.

It is a further object of the present invention to provide a method and apparatus for a navigation system to search and display object entries flexibly and quickly by classifying the entries into a plurality of ranges where the objects include POIs, prior destinations, local events, titles of entertainments, traffic incidents, etc.

One aspect of the present invention is a method for searching and displaying objects that are arranged by the selected range of desired parameters. The method includes the steps of: searching and retrieving candidate entries in a type of object specified by a user from a corresponding database; displaying a plurality of range keys on the screen of navigation system where a type of range assigned to the range keys is predetermined based on the type of object specified by the user; selecting a range by executing one of the range keys on the screen; and displaying a list of the candidate entries within the selected range on the screen.

In the method of the present invention, the step of displaying the list of the candidate entries within the selected range includes a step of displaying a value associated with each candidate entry through an entry value indicator on the screen. The step of displaying the list of the candidate entries further includes a step of displaying detailed information on one of the candidate entries through an entry information window on the screen. The step of displaying the list of the candidate entries further includes a step arranging the candidate entries in an order of distance from a specified position or an order of alphabet with respect to names of the candidate entries.

In the method of the present invention, the type of object specified by the user includes a POI (place of interest), a previous destination recorded in the navigation system, a local event within a specified area, and a traffic incident within a specified area.

In the method of the present invention, the type of range assigned to the range keys is distance between a specified location and the candidate entries where different distance ranges are assigned to the plurality of range keys so that the user selects one of them. Further, the type of range assigned to the range keys is time length to reach the candidate entries where different time length ranges are assigned to the plurality of range keys so that the user selects one of them.

In the further aspect of the present invention, the type of range assigned to the range keys is number of times of prior visit to the candidate entries where different number ranges are assigned to the plurality of range keys so that the user selects one of them. Furthermore, the type of range assigned to the range keys is price of product or service concerning candidate entries where different price ranges are assigned to the plurality of range keys so that the user selects one of them.

In the further aspect of the present invention, the type of range assigned to the range keys includes administrative area in which the candidate entries located where different area names are assigned to the plurality of range keys, and entertainment where different entertainment types are assigned to the plurality of range keys.

Another aspect of the present invention is an apparatus for a navigation system which enables a user to search the objects in a more quick and intuitive manner by arranging the candidate entries of object based on a plurality of ranges of various parameters. The apparatus of the present invention achieves this effects by implementing the various steps of the method of the present invention described above. The apparatus retrieves the desired information and displays them by dividing the retrieved candidate entries into the plurality of ranges.

According to the present invention, the navigation system enables to retrieve the desired information by dividing the retrieved candidate entries into a plurality of ranges of various parameters. The present invention provides the process and structure for flexibly and quickly searching the desired information classified into the plurality of ranges. By displaying a list of desired information (entries) that are classified by a selected range of desired parameter, the user is able to find a desired entry quickly and intuitively through the navigation screen. Various types of such ranges can be used which are appropriate to the type of information that are to be searched, such as distances from a current position or any specified position, time length to be reached, prices of products or services, numbers of prior visit, administrative areas such as city names, start times, types of entertainment, etc. Further, various types of information that are to be searched include points of interest (POI), prior destinations recorded in the system, local events such as sports, etc., titles of entertainments, traffic incidents. etc. The navigation system displays the plurality of range keys on the screen where the range keys represent ranges of desired parameters noted above. By selecting one of the range keys, the navigation system displays a list of requested entries within the selected range, thereby enabling to flexibly and quickly search the desired information divided into the plurality of ranges.

### BRIEF DESCRIPTION OF THE DRAWINGS

FIGS. 1A-1H are schematic diagrams showing an example of operational process and screen display involved in the navigation system for selecting a destination and conducting a route guidance operation to the destination.

FIG. 2 is a schematic diagram showing an example of screen display in the conventional navigation system where address book entries are listed in an alphabetical order for the user to select a desired entry among them.

FIG. 3 is a schematic diagram showing an example of display screen under an embodiment of the present invention where the screen includes a list of address book entries with a plurality of range keys.

FIG. 4 is a schematic diagram showing an example of display screen under another embodiment of the present invention where the screen includes a list of POI (point of interest) entries with corresponding entry value indicators, and a plurality of range keys.

FIGS. 5A-5C are schematic diagrams showing examples of screen display under the present invention for listing POI entries along with entry value indicators and an information window where the listed entries are classified by a plurality of distance ranges. FIG. 5A shows a case where the smallest distance range is selected, FIG. 5B shows a case where the second distance range is selected, and FIG. 5C shows a case where a threshold area between the two distance ranges is displayed by using up/down keys or scroll keys.

FIGS. 6A-6J are schematic diagrams showing examples of screen display under the present invention for listing entries of various types along with corresponding entry value indicators and an information window where the listed entries are classified by a plurality of ranges of desired parameters. FIG. 6A shows a list of gas station entries which are arranged by price ranges, FIG. 6B shows a list of restaurant entries which are arranged by ranges of the number of times that the place has been visited, FIG. 6C shows a list of restaurant entries which are arranged by ranges of the estimated time length to reach the entry location, FIG. 6D shows a list of restaurant entries which are arranged by administrative ranges such as city names, FIG. 6E shows a list of restaurant entries which are arranged by administrative ranges such as city names with the additional information of prices, FIG. 6F shows a list of restaurant entries which are arranged by administrative ranges such as city names with the additional information of numbers of prior visit, FIG. 6G shows a list of title entries which are selected by entertainment type range “Movie” with the additional information of start times, FIG. 6H shows a list of title entries which are selected by entertainment type range “Movie” with the additional information of ticket prices, FIG. 6I shows a list of local event entries which are arranged by the distance ranges, and FIG. 6J shows a list of traffic incident entries which are arranged by the distance ranges.

FIG. 7 is a flow chart showing an example of basic operational steps for displaying a list of selected type of entries organized by a plurality of ranges of desired parameters under the present invention.

FIG. 8 is a flow chart showing an example of basic operational steps for displaying a list of selected type of entries organized by a plurality of distance ranges under the present invention.

FIG. 9 is a flow chart showing an example of basic operational steps for displaying movie tile entries with additional information of start times or ticket prices shown in FIGS. 6G and 6H where a plurality of range keys are used to select an entertainment type.

FIG. 10 is a flow chart showing an example of basic operational steps of the present invention for displaying a list of traffic incident entries arranged by a plurality of distance ranges as shown in FIG. 6J.

FIG. 11 is a block diagram showing an example of functional structure of the apparatus under the present invention for listing the selected type of entries which are arranged by a plurality of desired parameter ranges.

FIG. 12 is a functional block diagram of a vehicle navigation system for implementing the method of the present invention for listing the selected type of entries which are arranged by a plurality of desired parameter ranges.

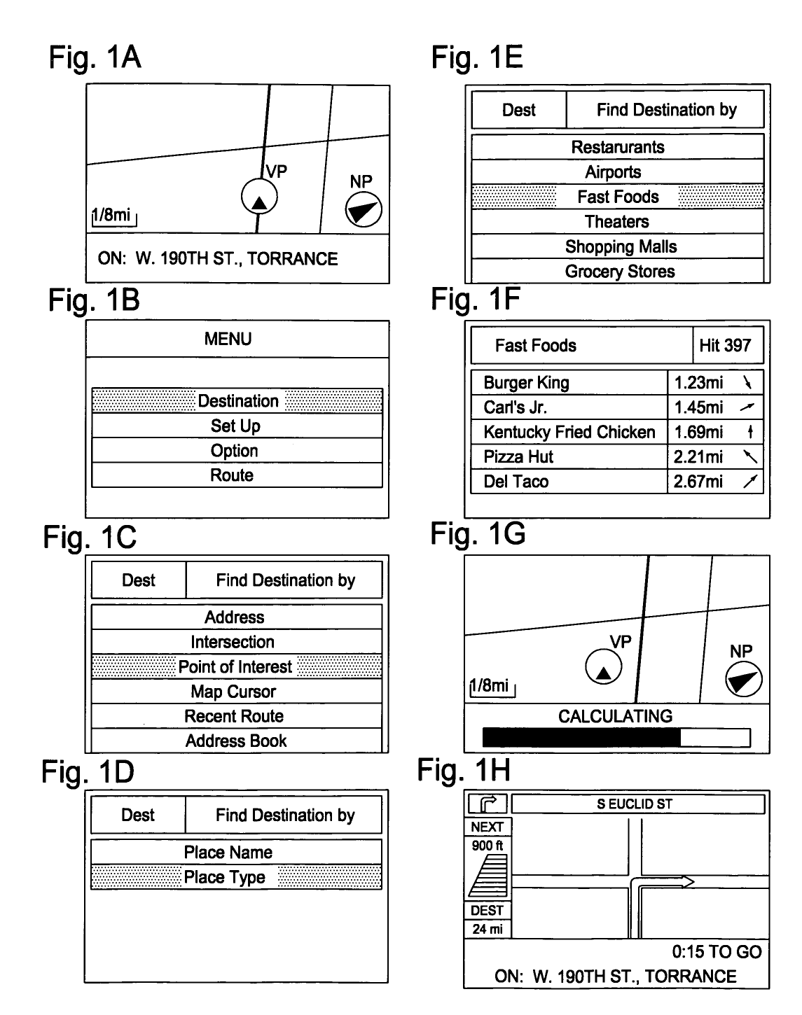

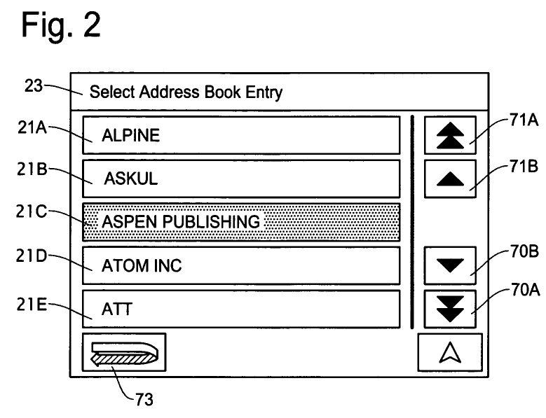

### DETAILED DESCRIPTION OF THE PREFERRED EMBODIMENT

The method and apparatus of the present invention for retrieving desired information by dividing into a plurality of ranges of various parameters is described in detail with reference to the accompanying drawings. The present invention is designed to provide the process and structure for flexibly and quickly searching the desired information classified into a plurality of ranges. By displaying a list of desired information (candidate entries) that are classified by a selected range of desired parameter, the user is able to find a desired entry quickly and intuitively through the navigation screen.

Various types or categories of such ranges will be used which are appropriate to the type of information that are to be searched, such as distances from a current position or other specified position, time length to reach, prices of products or services, numbers of prior visit, administrative areas such as city names, start times, types of entertainment, etc. Further, information on various types or categories of objects that are to be searched include points of interest (POI), prior destinations recorded in the system, local events such as sports, etc., titles of entertainments, traffic incidents. etc.

When the user selects a type of objects such as traffic incidents or selects a database such as a POI database, an address book, etc., for conducting a search operation, the navigation system retrieves the requested information from the database. The navigation system displays a plurality of range keys on the screen where the range keys represent ranges of desired parameters noted above. By selecting one of the range keys, the navigation system displays a list of requested entries such as POIs, prior destinations, etc. within the selected range.

Preferably, the navigation system provides additional information for each entry in the corresponding entry value indicator. Such additional information can be a particular distance to an entry from the current position of the user, a particular price of a ticket, or a particular start time of an event, etc. The range keys noted above can also be used to select a type of local event or local entertainment, typically when the navigation system is able to receive such information from a service provider through wireless communication. The navigation system also displays an information window which provides detailed information on the highlighted entry in the list such as an address, telephone number, business hour, etc.

Thus, the method and apparatus of the present invention is able to provide a flexible, convenient and quick way to search a desired object through the navigation system. A list of candidate objects can be retrieved from the database equipped in the navigation system or from a remote service provider. It should be noted that the present invention is described mainly for the case where the method and apparatus is applied to a vehicle navigation system, however, the method and apparatus under the present invention can be implemented to other devices, such as portable devices or personal computers, etc.

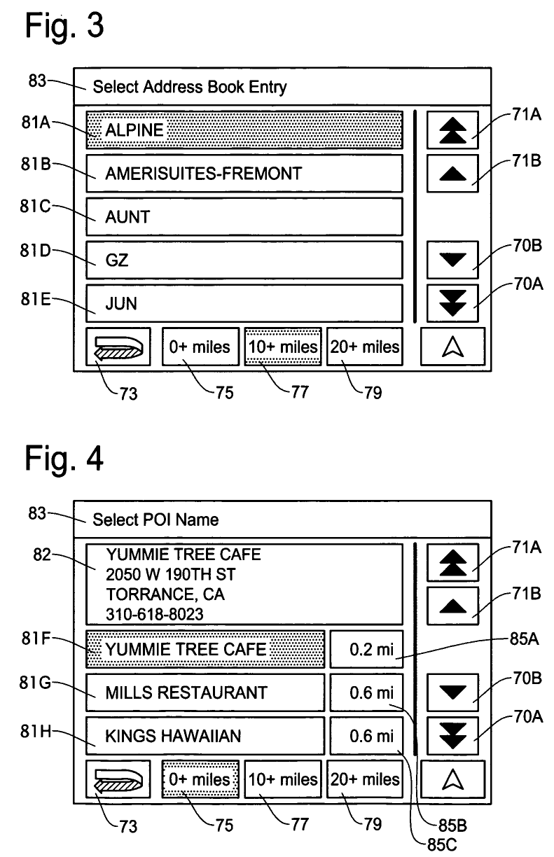

FIG. 3 is a schematic diagram showing an example of display screen under an embodiment of the present invention where the screen includes a list of address book entries and a plurality of range keys. This example shows the case where a list of candidate entries 81A-81E in the address book that reside within a selected distance range, in this case, between 10 and 20 miles, is illustrated on the screen. The user may scroll the list of FIG. 3 by pressing the scroll (up/down) keys 70A-70B and 71A-71B to see more entries in the list where the double arrow keys (70A and 71A) change the whole page up or down while the single arrow keys 70B and 71B change the entry one by one in the up or down direction. A back button 73 at the bottom is used to return to the previous screen.

In the present invention, range keys 75, 77, and 79 are provided at the bottom of the screen where each range key indicates the distance range. In this example, the distance key 75 indicates the distance range between 0 to 10 miles, the distance key 77 indicates the distance range between 10 to 20 miles, and the distance key 79 indicates the distance range over 20 miles. In this example, since the user has selected the distance range key 77, it is highlighted as shown in FIG. 3.

FIG. 4 is a schematic diagram showing an example of display screen under another embodiment of the present invention where the screen includes a list of candidate POI (point of interest) entries 81F-81H and corresponding entry value indicators 85A-85C, and a plurality of range keys 75-79. The example of FIG. 4 further shows an entry information window 82 that shows more detailed information on the highlighted POI entry 81F in the list. The range keys 75, 77, and 79 are provided to list the POI entries 81F-81H that reside within the selected distance range where, in this case, the range key 75 indicating a distance range “0-10 miles” is selected and highlighted.

Thus, by pressing one of the distance range keys 75, 77, and 79, the navigation system will list the entries that are located within the selected distance range from the current vehicle location or a location specified by the user. In this example, the distance between the current vehicle position or any specified position to the location of an entry is based on the radius, i.e., a point-to-point (straight line) distance. However, a driving distance to the location of the entry along a street may be used as well if computer resources allow such calculation.

Thus, on the screen of FIG. 4, the POI entries 81F-81H are listed which are located within the distance range between 0-10 miles from the current or specified position selected by the distance range key 75 now highlighted. The user is able to scroll the list by pressing the scroll (up/down) keys 70A-70B and 71A-71B as noted above. Next to the POI entries 81F-81H are the corresponding entry value indicators 85A-85C to show an actual distance value to the location of each of the POIs to show the additional information on each entry. As noted above, the entry information window 82 shows more detailed information on the highlighted POI entry 81F, such as an address and telephone number, etc.

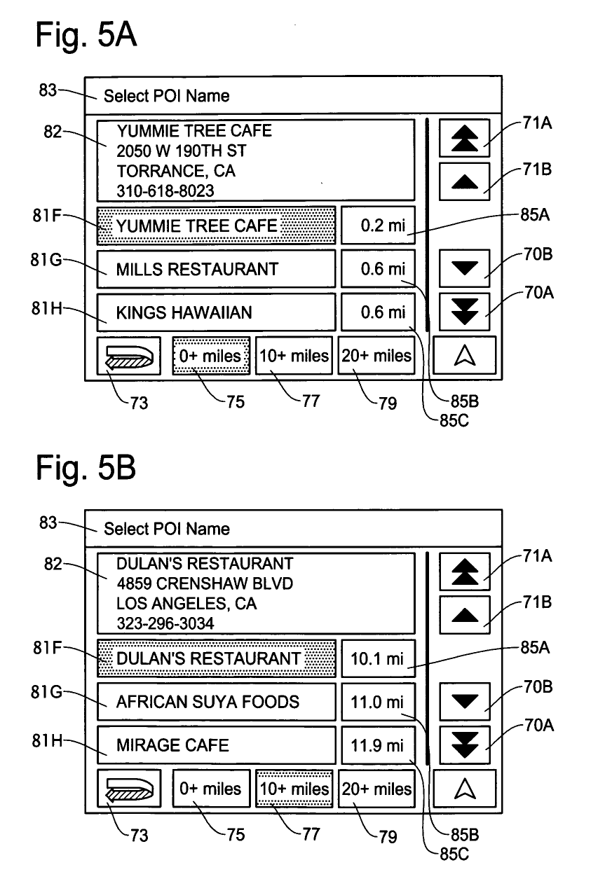

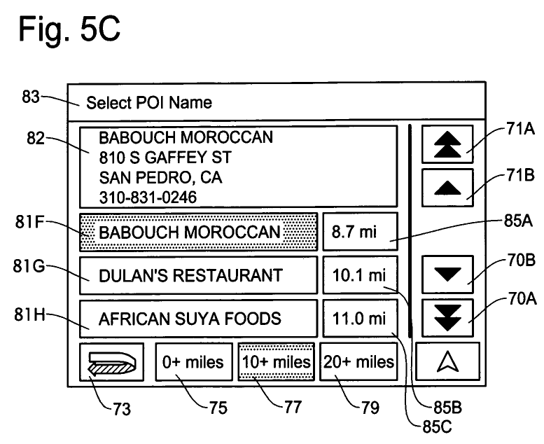

FIGS. 5A-5C are schematic diagrams showing examples of screen display under the present invention for listing POI entries along with corresponding entry value indicators and the information window where the listed entries are classified by a plurality of distance ranges. FIG. 5A shows a case where the smallest distance range is selected, FIG. 5B shows a case where the second distance range is selected, and FIG. 5C shows a case where a threshold area between the two distance ranges is displayed by using up/down keys or scroll keys.

In the example of FIGS. 5A-5C, the screen lists the candidate POI entries 81F-81H where the user is able to scroll the list by pressing the scroll (up/down) keys 70A-70B and 71A-71B as noted above. Next to the POI entries 81F-81H are the corresponding entry value indicators 85A-85C to show an actual distance value to the location of each of the POIs to provide the additional information on each entry. As noted above, the entry information window 82 shows more detailed information on the highlighted POI entry, such as an address and telephone number, on the highlighted POI entry.

In FIG. 5A, the distance range key 75 is activated so that the POI entries are listed which are located within the distance range 0-10 miles from the current vehicle position or from a specified position. Typically, the POI entries within the selected distance range are listed in the order of distance from the current vehicle position. Thus, the entry 81F (“YUMMIE TREE CAFE”) is the closest POI that is located at about 0.2 miles from the current position, followed by the entry 81G (“MILLS RESTAURANT”) that is located at about 0.6 miles from the current position where such actual values of the distance are indicated by the corresponding entry value indicators 85A-85C.

In FIG. 5B, the distance range key 77 is activated so that the POI entries are listed which are within the distance range 10-20 miles from the current vehicle position. Typically, the POI entries are listed in the order of distance from the current vehicle position. Thus, the entry 81F (“DULAN'S RESTAURANT”) that is located at about 10.1 miles from the current position is listed first followed by the entry 81G (“AFRICAN SUYA FOODS”) that is located at about 11.0 miles from the current position where such actual values of the distance are indicated by the corresponding entry value indicators 85A-85C. In this display example, the entry 81F (“DULAN'S RESTAURANT”) is highlighted and its detailed information is shown on the entry information window 82.

To see the POI entries in the threshold area between the two distance ranges, the user can select such entries by pressing the arrow (up/down) keys 71B and 70B. FIG. 5C shows an example of display when the arrow (up) key 71B is pressed in the situation of FIG. 5B. Thus, in FIG. 5C, the navigation system will show an entry that is more closer to the current position than the first entry shown in FIG. 5B. In other words, the navigation system shows the POI entry located at the distance smaller than 10 miles from the current vehicle position.

More specifically, even if the user has pressed the range key 77, the user is not limited to see the POI entries that are located within the specified distance range 10-20 miles from the current vehicle location. In this example, by pressing the up key 71B, the entry 81F (“BAROUCH MOROCCAN”) which is located at 8.7 miles from the current position is displayed. The entry 81F is highlighted and its information is shown on the entry information window 82. As noted above, the user may scroll the list of entries by pressing the scroll (up/down) keys 70A-70B and 71A-71B to see more entries in the list where the double arrow keys (70A and 71A) returns to the first or last entry while the single arrow keys 70B and 71B changes the entry on the screen one by one in the up or down direction.

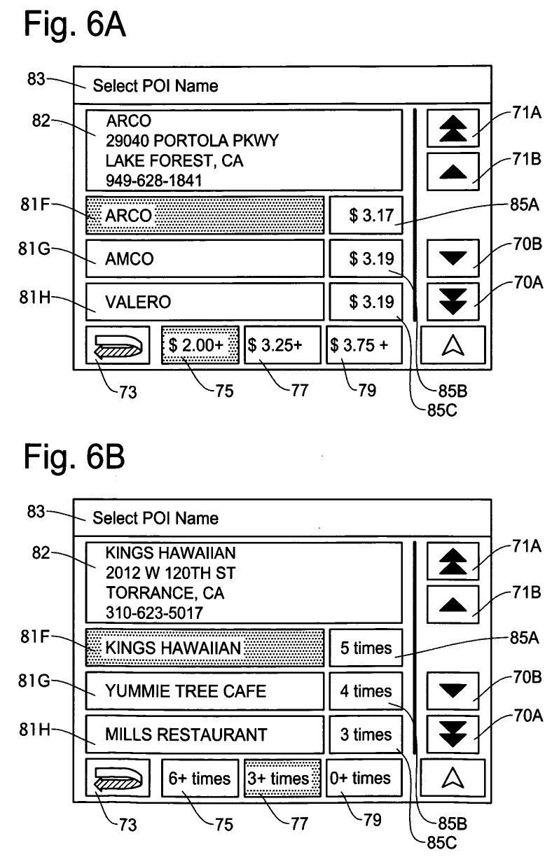

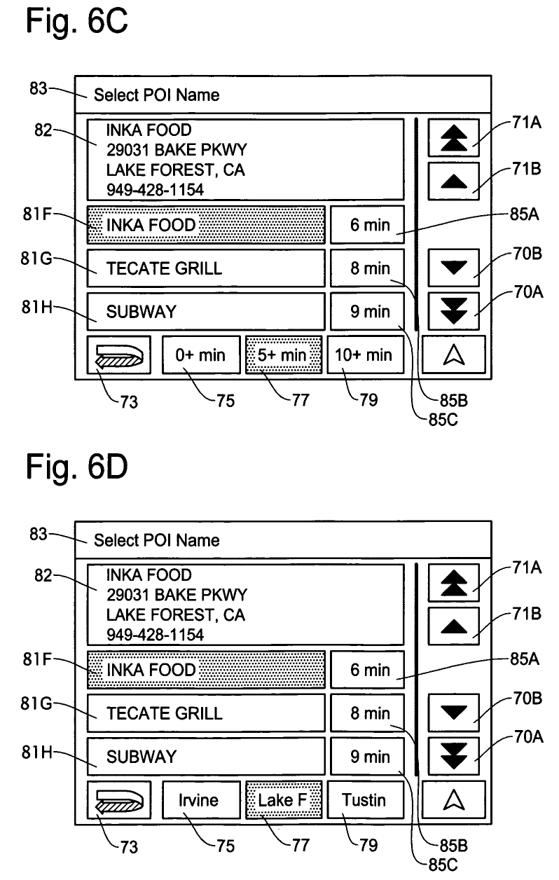

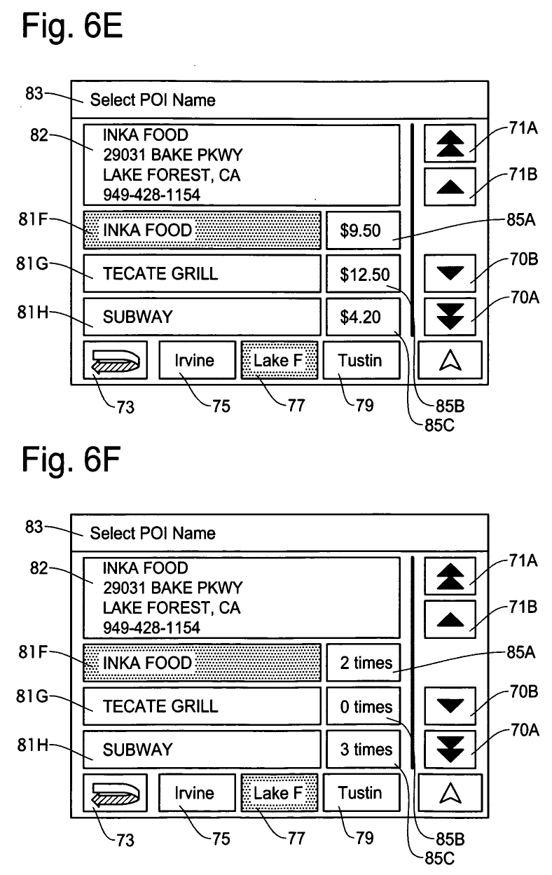

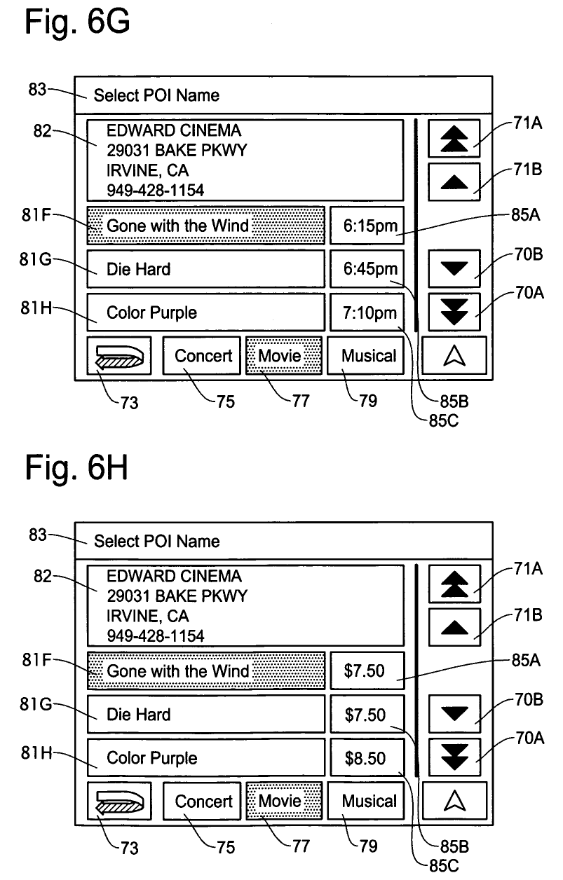

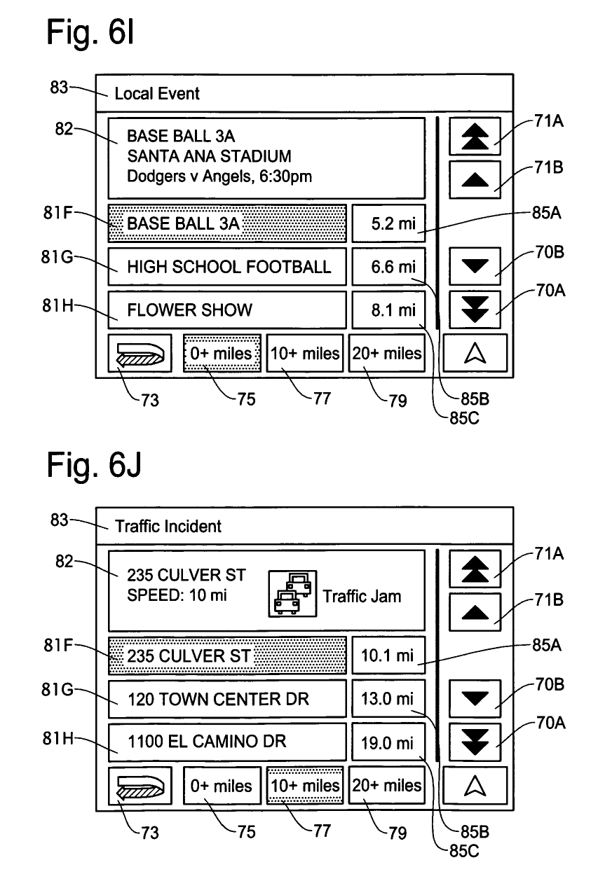

FIGS. 6A-6J are schematic diagrams showing examples of screen display under the present invention for listing candidate entries of various types along with the entry value indicators and an information window where the listed entries are classified by a plurality of ranges of desired parameters. In the example of FIGS. 6A-6J, the screen lists the candidate entries 81F-81H of selected type where the user is able to scroll the list by pressing the scroll (up/down) keys 70A-70B and 71A-71B as noted above. Next to the entries 81F-81H are the corresponding entry value indicators 85A-85C to an actual value (distance, price, time, etc.) of each entry to provide additional information on each entry. As noted above, the entry information window 82 shows more detailed information on the highlighted entry, such as an address and telephone number, etc.

In FIG. 6A, the navigation system shows a list of gas station entries which are arranged by price ranges where the range keys 75, 77, and 79 represent the price ranges of products or services, in this case, gas. In the example of FIG. 6A, the range key 75 is activated so that the gas station entries are listed which are within the price range $2.00-$3.25 indicated by the range key 75. Typically, the gas station entries are listed in the order of gas price, i.e, from low price to high price.

Thus, within this price range, the entry 81F (“ARCO”) shows the lowest gas price of $3.17 and is listed first, followed by the entry 81G (“AMCO”) with the gas price of $3.19. Such actual values of the gas prices at the gas stations are indicated by the corresponding entry value indicators 85A-85C. In this display example, the entry 81F (“ARCO”) is highlighted and its detailed information is shown in the entry information window 82.

In FIG. 6B, the navigation system shows a list of restaurant entries which are arranged by ranges of the number of times of prior visit where the range keys 75, 77, and 79 represent the ranges concerning the numbers of times of prior visit to the restaurants. In the example of FIG. 6B, the range key 77 is activated so that the restaurant entries are listed which are within the number range 3-6. Typically, the restaurant entries are listed in the order of number, i.e, from large number (visited more frequently) to small number (visited less frequently).

Thus, within this range of 3-6 times visit, the entry 81F (“KINGS HAWAIIAN”) is listed first which shows the highest number “5” indicating that the user of the navigation system has visited this restaurant five times in the past. The second entry is the entry 81G (“YUMMIE TREE CAFE”) which shows the second highest number “4”. Such actual numbers of prior visit are indicated by the corresponding entry value indicators 85A-85C. In this display example, the entry 81F (“KINGS HAWAIIAN”) is highlighted and its detailed information is shown in the entry information window 82.

In FIG. 6C, the navigation system shows a list of restaurant entries which are arranged by ranges of time length to reach the restaurants where the range keys 75, 77, and 79 represent the time ranges such as estimated drive times to reach the restaurants. In the example of FIG. 6C, the range key 77 is activated so that the restaurant entries are listed which are within the range of 5-10 minutes to reach. Typically, the restaurant entries are listed in the order of time length, i.e, from shorter time (reach quickly) to longer time (reach less quickly).

Thus, within this range, the entry 81F (“INKA FOOD”) is listed first which shows the shortest time number “6 minutes” indicating that the user of the navigation system can reach this restaurant in about six minutes. The second entry is the entry 81G (“TECATE GRILL”) which shows the second shortest time “8 minutes”. Such actual values of time length are indicated by the corresponding entry value indicators 85A-85C. In this display example, the entry 81F (“INKA FOOD”) is highlighted and its detailed information is shown in the entry information window 82.

In FIG. 6D, the navigation system shows a list of restaurant entries which are arranged by administrative regions where the range keys 75, 77, and 79 represent the city names. In the example of FIG. 6D, the range key 77 indicating a city “Lake Forest” is activated so that the restaurant entries are listed which are located within the administrative region of the city of “Lake Forest”. In this case, the restaurant entries are listed in the order of time length to reach there, i.e, from shorter time (reach quickly) to longer time (reach less quickly).

Thus, within this range, i.e., the city of “Lake Forest”, the entry 81F (“INKA FOOD”) is listed first which shows the shortest time “6 minutes” indicating that the user of the navigation system can reach this restaurant in about six minutes. The second one is the entry 81G (“TECATE GRILL”) which shows the second shortest time “8 minutes” to reach. Such actual values of time length are indicated by the corresponding entry value indicators 85A-85C. In this display example, the entry 81F (“INKA FOOD”) is highlighted and its detailed information is shown in the entry information window 82.

In FIG. 6E, similar to the case of FIG. 6D, the navigation system shows a list of restaurant entries which are arranged by administrative regions where the range keys 75, 77, and 79 represent the city names. Thus, the restaurant entries are listed which are located within the administrative region of the city of “Lake Forest”. In the example of FIG. 6E, unlike the example of FIG. 6D, the navigation system shows the price of food, for example, prices of typical dinner menu of the restaurants by the corresponding entry value indicators 85A-85C.

In FIG. 6F, similar to the case of FIGS. 6D and 6E, the navigation system shows a list of restaurant entries which are arranged by administrative regions where the range keys 75, 77, and 79 represent the city names. Thus, the restaurant entries are listed which are located within the administrative region of the city of “Lake Forest”. In the example of FIG. 6E, however, the navigation system shows the numbers of times of prior visit to the restaurants by the corresponding entry value indicators 85A-85C.

In FIG. 6G, the navigation system shows a list of title entries which are arranged by types of entertainment where the range keys 75, 77, and 79 represent the types of entertainment. In the example of FIG. 6D, the range key 75 represents an entertainment type of “Concert”, the range key 77 represents an entertainment type of “Movie”, and the range key 79 represents an entertainment type of “Musical”. Here, the range key 77 indicating the “Movie” is activated so that the movie titles at the nearby movie theater are listed on the screen. In this case, the movie titles are listed in the order of their start times, i.e, from the that starts earlier to that starts later.

Thus, within this selected category of entertainment, i.e., the “Movie”, at the nearby movie theater “EDWARD CINEMA”, the entry 81F (“GONE WITH THE WIND”) is listed first which starts at the earliest time 6:15 pm. The second is the entry 81G (“DIE HARD”) which starts the next at 6:45 pm. Such actual values of start time are indicated by the corresponding entry value indicators 85A-85C. In this display example, the detailed information on the movie theater “EDWARD CINEMA”, such as an address and a telephone number, is shown in the entry information window 82.

In FIG. 6H, similar to the case of FIG. 6G, the navigation system shows a list of movie title entries which are retrieved by selecting the type of entertainment assigned to the range keys 75, 77, and 79. Since the range key 77 indicating the “Movie” is activated, the movie titles at the closest movie theater are listed on the screen. In the example of FIG. 6H, however, rather than the start times shown in FIG. 6G, the navigation system shows the ticket price of the movie title by the corresponding entry value indicators 85A-85C.

In FIG. 6I, the navigation system shows a list of local events entries which are arranged by the distance from the current vehicle position where the range keys 75, 77, and 79 represent the distance range. In the example of FIG. 6I, the range key 75 indicating the distance range “0-10 miles” from the current position is activated so that the local events within this distance range are listed on the screen. Such information concerning the local events within a predetermined distance from the current position or within a specified area can be retrieved from the service provider when the navigation system equips a communication function to receive such information through wireless communication.

In this case, the local events are listed in the order of distance from the current position. Thus, within this selected distance range, i.e., 0-10 miles, the entry 81F (“BASE BALL 3A”) is listed first whose location is 5.2 miles from the current vehicle position. The second one is the entry 81G (“HIGH SCHOOL FOOTBALL”) which will take place at a location 6.6 miles away from the current position. Such actual values of distance are indicated by the corresponding entry value indicators 85A-85C. In this display example, the entry 81F (“BASE BALL 3A”) is highlighted and its detailed information is shown in the entry information window 82.

In FIG. 6J, the navigation system shows a list of traffic incident entries which are arranged by the distance from the current vehicle position where the range keys 75, 77, and 79 represent the distance range. In the example of FIG. 6J, the range key 77 indicating the distance range “10-20 miles” from the current position is activated so that the traffic incidents within this distance range are listed on the screen. Such information concerning the traffic incidents within a predetermined distance from the current position or within a specified area can be retrieved from the service provider when the navigation system equips a communication function to receive such information through wireless communication.

In this case, the traffic incidents are listed in the order of distance from the current position. Thus, within this selected distance range, i.e., 10-20 miles, the entry 81F (“235 CULVER ST”) is listed first whose location is 10.1 miles from the current vehicle position. The second one is the entry 81G (“120 TOWN CENTER DR”) which is located at 13.0 miles away from the current position. Such actual values of distance are indicated by the corresponding entry value indicators 85A-85C. In this display example, the entry 81F (“235 CULVER ST”) is highlighted and its detailed information is shown in the entry information window 82 with a corresponding traffic incident icon.

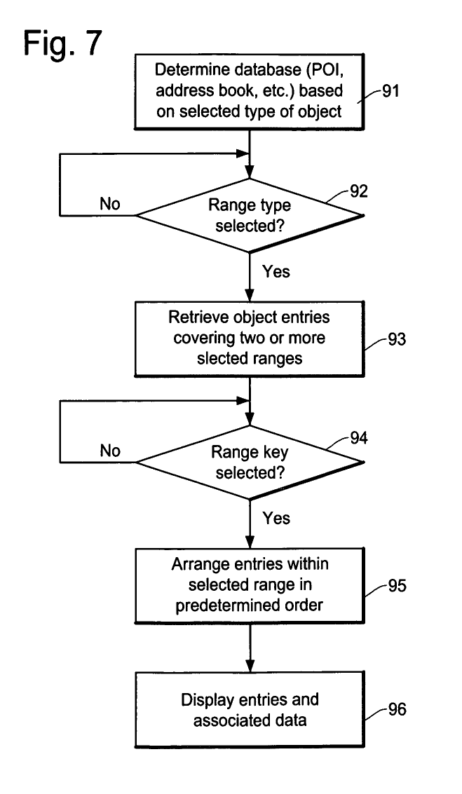

FIG. 7 is a flow chart showing an example of basic operational steps for displaying a list of selected type of entries organized by a plurality of ranges of desired type or parameters under the present invention. The selected type of entries includes the prior destinations stored in the address book of the navigation system as in the example of FIG. 3, or POIs such as gas stations, restaurants, etc., as in the examples of FIGS. 4, 5A-5C, 6A-6F, or other information such as local events, traffic incidents, titles of movie, drama and musical (entertainment), etc. as in the examples of FIGS. 6G-6J. Further, various types or parameters of ranges can also be used, examples of which include distances from a current position or a specified position, time lengths to be reached, prices of objects, numbers of prior visit, administrative areas such as city names, types of entertainment, etc.

As the procedure starts, the user selects a type of object that he/she wants to search, for example, a prior destination as shown in FIG. 3 or a point of interest (POI) as shown in FIG. 4. Thus, the navigation system determines an appropriate database for retrieving information on such objects, for example, the address book, POI database, remote database, etc., in the step 91. Then, the navigation system checks whether the range type, such as a distance range, a time range, or a price range, etc., is selected by the user in the step 92.

When the range type is selected in the step 92, the navigation system retrieves the selected type of objects (entries) from the selected database in the step 93. As noted above, the present invention is designed to allow the user to select a desired range out of a plurality of ranges when displaying the retrieved entries. Thus, the navigation system preferably retrieves all the candidate entries which are sufficient to extend over the plurality of ranges, which will be temporarily stored in a memory.

In the step 94, the navigation system checks whether one of the ranges is selected by the user through the operation of the range keys on the screen. In the examples noted above, three range keys 75, 77 and 79 are provided on the screen among which the user selects one of the range keys. For example, in FIG. 6A, the user has selected the range key 75 which represents the price range of “$2.00-$3.25” of the gas. In the example of FIG. 6B, the user has selected the range key 77 which represents the number “3 or more” of prior visit to the restaurants.

Then, in the step 95, the navigation system arranges the retrieved entries that belong to the selected range in the predetermined order. For example, in FIG. 3, the navigation system arranges the prior destinations within the distance range of “10-20 miles” retrieved from the address book. The candidate entries are arranged in the predetermined order such as an order of distance from the current position, or an order of alphabet with respect to the entry names, etc. In the step 96, the navigation system displays the list of entries within the selected range in the predetermined order. Further, preferably, the navigation system displays the associated data such as detailed information on the highlighted entry in the entry information window 82 on the screen as shown in FIGS. 4, 5A-5C and 6A-6J.

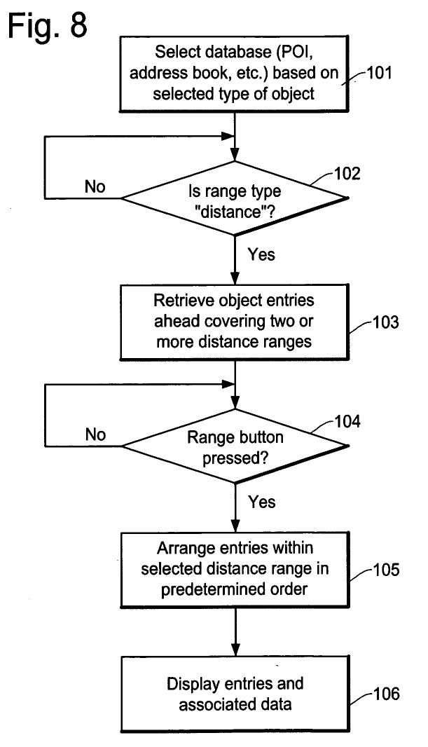

FIG. 8 is a flow chart showing an example of basic operational steps for displaying a list of selected type of entries organized by a plurality of distance ranges under the present invention. In other words, the flow chart of FIG. 8 is a special case of the generic operation of FIG. 7 where the distance rages are used for classifying the retrieved objects. As noted above, the selected type of entries may vary which includes the prior destinations, POIs, local events, traffic incidents, etc. In the flow chart of FIG. 8, as noted above, the range type is limited to the distance from the current position or any position specified by the user.

As the procedure starts, the user selects a type of object that he/she wants to search, for example, a prior destination as shown in FIG. 3 or a POI as shown in FIGS. 4 and 5A-5C. Based on the specified type of objects, the navigation system determines an appropriate database for such objects, for example, the address book, POI database, etc., in the step 101. Then, the navigation system checks whether the range type is a distance from the current vehicle position in the step 102.

When the range type is distance, the navigation system retrieves the selected type of objects (entries) from the selected database in the step 103. As noted above, the present invention is designed to allow the user to select a desired distance range out of a plurality of ranges when displaying the retrieved entries. Thus, the navigation system preferably retrieves all the candidate entries which are sufficient to extend over the plurality of distance ranges, which may be temporarily stored in a memory.

In the step 104, the navigation system checks whether one of the distance ranges is selected by the user through the operation of the range keys on the screen. In the examples noted above, three range keys 75, 77 and 79 are provided on the screen among which the user selects one of the range keys. For example, in FIG. 5A, the user has selected the range key 75 which represents the distance range of “0-10 miles” from the current position.

Then, in the step 105, the navigation system arranges the entries within the selected distance range in the predetermined order. For example, in the example of FIG. 5A, the navigation system arranges the restaurants within the distance range of “0-10 miles” retrieved from the POI database. The entries are arranged in the predetermined order such as an order of distance from the current position as shown in FIG. 5A, or order of alphabet, etc. In the step 106, the navigation system displays the list of candidate entries within the selected distance range. Further, the navigation system displays the detailed information on the highlighted entry in the entry information window 82 on the screen as shown in FIGS. 5A-5C and 6A-6J.

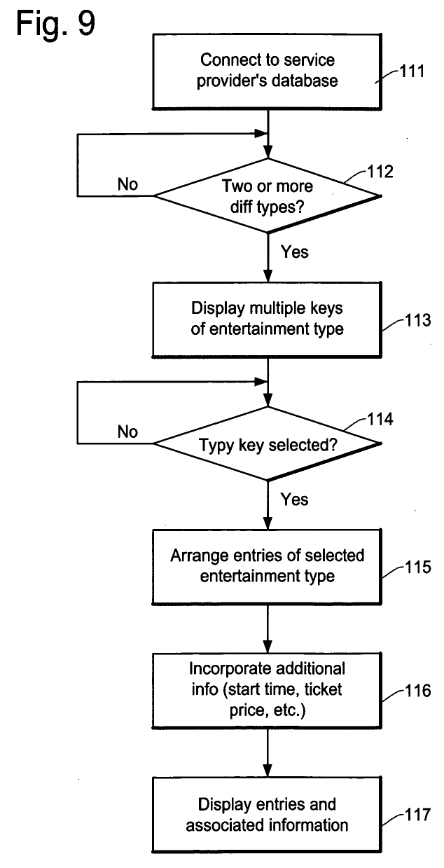

FIG. 9 is a flow chart showing an example of basic operational steps for displaying the movie tile entries with additional information of start times or ticket prices shown in FIGS. 6G and 6H where a plurality of range keys are used to select an entertainment type. In other words, the operation of FIG. 9 is a special case of the generic operation of FIG. 7 where the range keys are used for classifying the types of entertainments. As noted above, the selected type of entries may vary which includes the prior destinations, POIs, local events, traffic incidents, etc. In the flow chart of FIG. 9, as noted above, the range keys are assigned to select a type of entertainment, such as movie, musical, drama, concerts, etc.

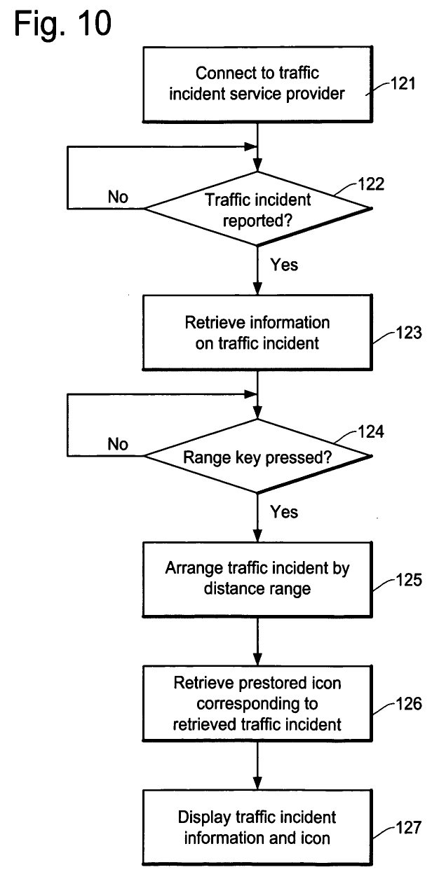

As the procedure starts, in the step 111, the navigation system connects to a database of service provider which typically provides information concerning recreation and entertainment to subscribed members. Typically, the navigation system is able to receive such information from the service provider through wireless communication with use of the wireless transceiver installed therein (ex. wireless transceiver 149 in FIG. 10). In the step 112, based on the information from the service provider, the navigation system determines whether there are information on two or more different types of entertainment available.

In the step 112, if it is determined that the service provider is able to provide information on the two or more different types of entertainment, the navigation system assigns such entertainment types to the range keys 75-79 on the screen in the step 113. In the example of FIGS. 6G and 6H, the three range keys 75, 77 and 79 are provided on the screen which represent the entertainment types of “Concert”, “Movie” and “Musical”, respectively. Then, in the step 114, the navigation system checks whether one of the entertainment types is selected by the user through the operation of the range keys on the screen.

If the user has selected one of the range keys, as in the example of FIGS. 6G and 6H where the user has selected the range key 77 indicating the entertainment type “Movie”, the navigation system proceeds to the step 115 to retrieve the information concerting the movie. For example, the navigation system retrieves the movie information regarding the nearby movie theater “EDWARD CINEMA”. In the step 115, the navigation system arranges the title of the movie played in the movie theater in the predetermined order.

An example of such an order is an alphabetical order where the candidate movie titles are listed in the order of alphabet or an order of the time of first release of the movie, etc. In another example, the movie titles are listed in the order of start time as shown in FIG. 6G from the one starts earlier to the one starts later. In a further example, the movie titles are listed in the order of ticket price as shown in FIG. 6H from the one less expensive to the one more expensive.

Then, in the step 116, the navigation system incorporates the additional information for each movie title through the entry value indicators 85A-85C. In the example of FIG. 6G, the entry value indicators 85A-85 show the start times, and in the example of FIG. 6H, the entry value indicators 85A-85 show the ticket prices. Finally, in the step 117, the navigation system displays the list of entries, movie titles, in the predetermined order, the entry value indicators 85A-85, and the detailed information on the movie theater, such as an address and a telephone number in the entry information window 82.

FIG. 10 is a flow chart showing an example of basic operational steps of the present invention for displaying a list of traffic incident entries arranged by a plurality of distance ranges as shown in FIG. 6J. In other words, the operation of FIG. 10 is a special case of the generic operation of FIG. 7 where the object to retrieve is a traffic incident and the range keys are used for classifying the traffic incidents by distance ranges. As noted above, the selected type of entries in the case is traffic incidents, etc., thus the operation of FIG. 10 is directed to the case for retrieving and displaying the traffic incident information arranged by the distance range.

As the procedure starts, in the step 121, the navigation system connects to a traffic incident service provider which is typically a public organization to provide information on the local traffic situations. Typically, the navigation system is able to receive such information from the service provider through wireless communication with use of the wireless transceiver installed therein (ex. wireless transceiver 149 in FIG. 10). In the step 122, based on the information from the service provider, the navigation system determines whether there are information on traffic incidents reported within a predetermined distance such as 30 miles from the current position.

In the step 122, if it is determined that the service provider is able to provide information on the traffic incidents within the predetermined distance, the navigation system assigns such distance ranges to the range keys 75-79 on the screen in the step 123. In the example of FIG. 6J, the three range keys 75, 77 and 79 are provided on the screen which represent the distance ranges of “0-10 miles”, “10-20 miles” and “20-30 miles”, respectively. Then, in the step 124, the navigation system checks whether one of the distance range is selected by the user through the operation of the range keys.

The user selects one of the range keys, for example, as shown in FIG. 6J, the user has selected the range key 77 indicating the distance range “10-20 miles”. The navigation system proceeds to the step 125 to retrieve the information concerning the traffic incident within the distance range “10-20 miles” from the current vehicle position. In the step 125, the navigation system arranges the traffic incidents within the selected distance range in the predetermined order, such as an order of distance from the current position as shown in FIG. 6J.

Then, in the step 126, the navigation system retrieves icons indicating types of traffic incident pre-established in the navigation system. Finally, in the step 127, the navigation system displays the list of traffic incidents occurred within the selected distance range in the predetermined order, as well as the entry value indicators 85A-85 which show the actual distances to the locations of the traffic incidents. Further, the navigation system displays the detailed information on the highlighted traffic incident with the assigned icon in the entry information window 82 on the screen.

It should be noted that the procedure of the steps described above are merely an example, and that the person skilled in the art or the man skilled in the art would understand that the order of each step may be adjusted or altered according to a desired implementation without departing the scope and spirit of the invention.

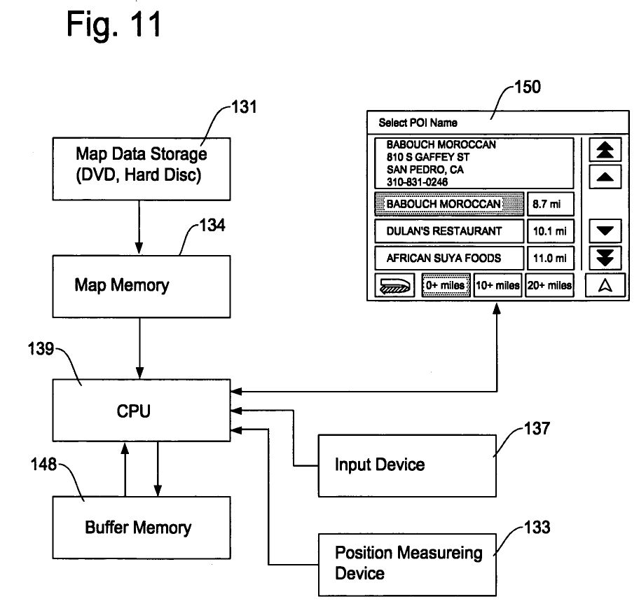

FIG. 11 is a functional block diagram showing an example of basic structure of the display apparatus of the present invention for searching and displaying the object entries arranged by a selected range of various parameters on the screen of the navigation system. The structure of FIG. 11 is applicable to any electronic device having a navigation function which enables the electronic device to guide the user to a particular location as noted above. The display apparatus of the present invention includes a monitor 150 for graphical user interface, and a controller (CPU) 139 for controlling an overall operation of the apparatus of the present invention.

The block diagram of FIG. 11 further includes a map data storage 131 such as a DVD or a hard disc for storing map data, a map memory 134 for storing a required portion of the map data retrieved from the map data storage 131, an input device 137 such as a joystick, a remote controller or other input device for the user to select menus, change directions, scroll the screen, change the location of the cursor on the screen, etc., a position measuring device 133 for detecting a current position of the user, and a buffer memory 148 for storing the retrieved data such as prior destinations, point of interest (POI), etc.

In FIG. 11, the display apparatus under the present invention is able to retrieve the map data from the map data storage 131 and the map memory 134. Based on the retrieved map data, the display apparatus displays a map image, a calculated route to the destination, or a list of object entries and a plurality of range keys, etc., on the monitor 150. The CPU 139 controls an overall operation of the efficient object search and display operation using the range keys under the present invention.

When the user selects a type of object that he/she wants to search, for example, a prior destination or a point of interest (POI), the CPU 139 determines an appropriate database for retrieving such objects. The CPU 139 checks whether the range type, such as a distance range, a time range, or a price range, etc., is selected. The CPU 139 retrieves the selected type of objects from the selected database and checks whether one of the ranges is selected by the range keys on the screen.

In the examples noted above, three range keys 75, 77 and 79 are provided on the screen among which the user selects one of the range of desired parameters. The CPU 139 arranges the retrieved entries that belong to the selected range in the predetermined order, such as an order of distance from the current position, or order of alphabet, etc. Then, the CPU 139 displays the list of entries within the selected range in the predetermined order.

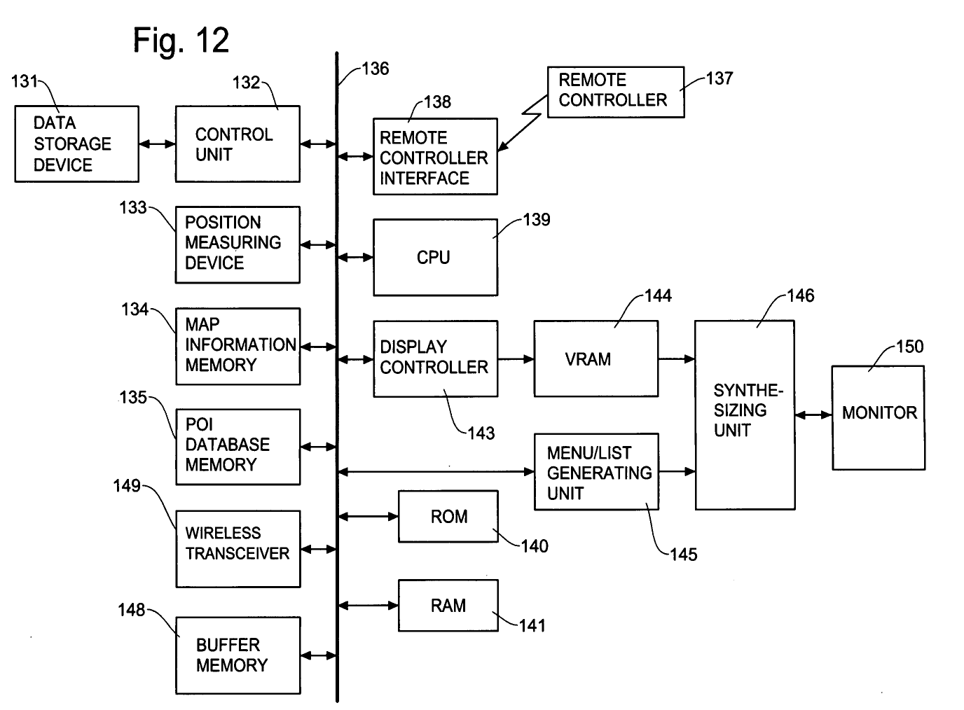

FIG. 12 shows an example of structure of a vehicle navigation system for implementing the display method of the present invention for searching and listing objects arranged by ranges of various parameters. While the vehicle navigation system is explained for an illustration purpose, the present invention can also be applied to other types of navigation system, such as a portable navigation device implemented by a PDA (personal digital assistant) device, other hand-held devices such as a wireless telephone, a wrist watch, a laptop or notebook computer.

In the block diagram of FIG. 12, the functional blocks similar to those of FIG. 11 are denoted by the same reference numerals. The navigation system includes a data storage medium 131 such as a hard disc, CD-ROM, DVD or other storage means for storing the map data. The navigation system includes a control unit 132 for controlling an operation for reading the information from the data storage medium 131, and a position measuring device 133 for measuring the present vehicle position or user position. For example, the position measuring device 133 has a vehicle speed sensor for detecting a moving distance, a gyroscope for detecting a moving direction, a microprocessor for calculating a position, a GPS (global positioning system) receiver for receiving and analyzing GPS signals, and etc.

The block diagram of FIG. 12 further includes a map information memory 134 for storing a portion of the map data relevant to the intended operation of the navigation system which is read from the data storage medium 131, a database memory 135 for storing database information such as point of interest (POI) information which is read out from the data storage medium 131, a remote controller 137 for executing a menu selection operation, cursor movements, an enlarge/reduce operation, a destination input operation, etc. and a remote controller interface 138. Although a remote controller is a typical example for selecting menus, executing selected functions and etc., the navigation system includes various other input methods to achieve the same and similar operations done through the remote controller.

In FIG. 12, the navigation system further includes a bus 136 for interfacing the above functional blocks in the system, a processor (CPU) 139 for controlling an overall operation of the navigation system, a ROM 140 for storing various control programs such as a route search program and a map matching program necessary for navigation control as well as a local brand icon display program for the present invention, a RAM 141 for storing a processing result such as a guide route, a display controller 143 for generating map image (a map guide image and an arrow guide image) on the basis of the map information, a VRAM 144 for storing images generated by the display controller 143, a menu/list generating unit 145 for generating menu image/various list images, a synthesizing unit 146, a wireless transceiver 149 for wireless communication to retrieve data from a remote server, a buffer memory 148 for temporally storing data such as information on the objects (entries) retrieved from the POI database, address book, etc., for displaying them in the manner arranged based on the selected range keys.

The CPU 139 controls an overall operation of the navigation system including the object search and display method under the present invention. The retrieved data concerning the objects will be stored in the buffer memory 148 for further processing. As noted above, the navigation system conducts the process of retrieving and displaying the retrieved information in the manner arranged by the selected ranges of desired parameters, thereby enabling to flexibly and quickly search the desired information classified into a plurality of ranges.

A program that performs the procedure of the present invention including the ones shown in the flow charts of FIGS. 7-10 may be stored in the ROM 140 or other storage medium and is executed by the CPU 139. As noted above, the buffer memory 148 may be used for storing the data related to the retrieved objects for displaying on the screen in the manner arranged by selected ranges. Thus, the user is able to find the desired objects easily and quickly on the screen of the navigation system.

As has been described above, according to the present invention, the navigation system enables to retrieve the desired information by dividing the retrieved candidate entries into a plurality of ranges of various parameters. The present invention provides the process and structure for flexibly and quickly searching the desired information classified into the plurality of ranges. By displaying a list of desired information (entries) that are classified by a selected range of desired parameter, the user is able to find a desired entry quickly and intuitively through the navigation screen. Various types of such ranges can be used which are appropriate to the type of information that are to be searched, such as distances from a current position or any specified position, time length to be reached, prices of products or services, numbers of prior visit, administrative areas such as city names, start times, types of entertainment, etc. Further, various types of information that are to be searched include points of interest (POI), prior destinations recorded in the system, local events such as sports, etc., titles of entertainments, traffic incidents. etc. The navigation system displays the plurality of range keys on the screen where the range keys represent ranges of desired parameters noted above. By selecting one of the range keys, the navigation system displays a list of requested entries within the selected range, thereby enabling to flexibly and quickly search the desired information divided into the plurality of ranges.

Although the invention is described herein with reference to the preferred embodiment, one skilled in the art will readily appreciate that various modifications and variations may be made without departing from the spirit and scope of the present invention. Such modifications and variations are considered to be within the purview and scope of the appended claims and their equivalents.

What is claimed is:

1. A method for searching and displaying candidate entries on a screen of a navigation system, comprising the following steps of:
searching and retrieving candidate entries in a type of object specified by a user from a corresponding database;
displaying a plurality of range keys on the screen of navigation system where a type of range assigned to the range keys is predetermined based on the type of object specified by the user;
selecting a range by executing one of the range keys on the screen; and
displaying a list of the candidate entries within the selected range on the screen.

2. A method for searching and displaying candidate entries as defined in claim 1, wherein said step of displaying the list of the candidate entries within the selected range includes a step of displaying a value associated with each candidate entry through an entry value indicator on the screen.

3. A method for searching and displaying candidate entries as defined in claim 1, wherein said step of displaying the list of the candidate entries within the selected range includes a step of displaying a value associated with each candidate entry through an entry value indicator on the screen, and a step of displaying detailed information on one of the candidate entries through an entry information window on the screen.

4. A method for searching and displaying candidate entries as defined in claim 1, wherein said step of displaying the list of the candidate entries within the selected range includes a step of arranging the candidate entries in an order of distance from a current position of the user or any specified position, or an order of alphabet with respect to names of the candidate entries.

5. A method for searching and displaying candidate entries as defined in claim 1, wherein said type of object specified by the user includes a POI (place of interest), a previous destination recorded in the navigation system, a local event within a specified area, and a traffic incident within a specified area.

6. A method for searching and displaying candidate entries as defined in claim 1, wherein said type of range assigned to the range keys is distance between a specified location and the candidate entries where different distance ranges are assigned to the plurality of range keys so that the user selects one of them.

7. A method for searching and displaying candidate entries as defined in claim 1, wherein said type of range assigned to the range keys is time length to reach the candidate entries where different time length ranges are assigned to the plurality of range keys so that the user selects one of them.

8. A method for searching and displaying candidate entries as defined in claim 1, wherein said type of range assigned to the range keys is number of times of prior visit to the candidate entries where different number ranges are assigned to the plurality of range keys so that the user selects one of them.

9. A method for searching and displaying candidate entries as defined in claim 1, wherein said type of range assigned to the range keys is price of product or service concerning candidate entries where different price ranges are assigned to the plurality of range keys so that the user selects one of them.

10. A method for searching and displaying candidate entries as defined in claim 1, wherein said type of range assigned to the range keys includes administrative area in which the candidate entries located where different area names are assigned to the plurality of range keys, and entertainment where different entertainment types are assigned to the plurality of range keys.

11. An apparatus for searching and displaying candidate entries on a screen of a navigation system, comprising:
means for searching and retrieving candidate entries in a type of object specified by a user from a corresponding database;
means for displaying a plurality of range keys on the screen of navigation system where a type of range assigned to the range keys is predetermined based on the type of object specified by the user;
means for selecting a range by executing one of the range keys on the screen; and
means for displaying a list of the candidate entries within the selected range on the screen.

12. An apparatus for searching and displaying candidate entries as defined in claim 11, wherein said means for displaying the list of the candidate entries within the selected range includes means for displaying a value associated with each candidate entry through an entry value indicator on the screen.

13. An apparatus for searching and displaying candidate entries as defined in claim 11, wherein said means for displaying the list of the candidate entries within the selected range includes means for displaying a value associated with each candidate entry through an entry value indicator on the screen, and means for displaying detailed information on one of the candidate entries through an entry information window on the screen.

14. An apparatus for searching and displaying candidate entries as defined in claim 11, wherein said means for displaying the list of the candidate entries within the selected range includes means for arranging the candidate entries in an order of distance from a current position of the user or any specified position, or an order of alphabet with respect to names of the candidate entries.

15. An apparatus for searching and displaying candidate entries as defined in claim 11, wherein said type of object specified by the user includes a POI (place of interest), a previous destination recorded in the navigation system, a local event within a specified area, and a traffic incident within a specified area.

16. An apparatus for searching and displaying candidate entries as defined in claim 11, wherein said type of range assigned to the range keys is distance between a specified location and the candidate entries where different distance ranges are assigned to the plurality of range keys so that the user selects one of them.

17. An apparatus for searching and displaying candidate entries as defined in claim 11, wherein said type of range assigned to the range keys is time length to reach the candidate entries where different time length ranges are assigned to the plurality of range keys so that the user selects one of them.

18. An apparatus for searching and displaying candidate entries as defined in claim 11, wherein said type of range assigned to the range keys is number of times of prior visit to the candidate entries where different number ranges are assigned to the plurality of range keys so that the user selects one of them.

19. An apparatus for searching and displaying candidate entries as defined in claim 11, wherein said type of range assigned to the range keys is price of product or service concerning candidate entries where different price ranges are assigned to the plurality of range keys so that the user selects one of them.

20. An apparatus for searching and displaying candidate entries as defined in claim 11, wherein said type of range assigned to the range keys includes administrative area in which the candidate entries located where different area names are assigned to the plurality of range keys, and entertainment where different entertainment types are assigned to the plurality of range keys.
